(19) United States
(12) Patent Application Publication
(10) Pub. No.: US 2025/0138165 A1
(43) Pub. Date: May 1, 2025

(54) INFORMATION PROCESSING DEVICE, INFORMATION PROCESSING METHOD AND TIME-OF-FLIGHT SYSTEM

(71) Applicant: Sony Semiconductor Solutions Corporation, Atsugi-shi, Kanagawa (JP)

(72) Inventors: Gianluca AGRESTI, Stuttgart (DE); Henrik SCHÄFER, Stuttgart (DE); Yalcin INCESU, Stuttgart (DE)

(73) Assignee: Sony Semiconductor Solutions Corporation, Atsugi-shi, Kanagawa (JP)

(21) Appl. No.: 18/687,822

(22) PCT Filed: Sep. 5, 2022
(86) PCT No.: PCT/EP2022/074598

§ 371 Date: Feb. 29, 2024

(30) Foreign Application Priority Data
Sep. 7, 2021 (EP) 21195195.9

(51) Int. Cl. G01S 7/4865; G01S 7/48; G01S 17/894; H04N 25/705

(52) U.S. Cl. CPC G01S 7/4865; G01S 7/4808; G01S 17/894; H04N 25/705

(57) ABSTRACT

An information processing device (13) for a time-of-flight, ToF, system (10) including circuitry configured to: obtain time-of-flight data of at least one time-of-flight measurement of light reflected from a scene (14) that is illuminated with infrared light; and input the time-of-flight data into a neural network (20), wherein the neural network (20) is trained to estimate, for each pixel or a subset of pixels of the time-of-flight data, a spatially varying bidirectional reflection distribution function, svBRDF. The ToF system (10) includes an illumination device (11) and an imaging device (12). The scene (14) includes an object (15) which reflects at least partially infrared illumination light. The imaging device (12) includes an optical lens portion (16), an image sensor (17) and a control (18). In embodiments, the circuitry of the information processing device (13) generates at least one of amplitude data, intensity data and depth data and inputs any combination of the correlation data, the amplitude data, the intensity data and the depth data into the neural network (20) for the estimation of the svBRDF. It has been recognized that a training based on synthetic scenes may be improved for the application to real time-of-flight data by a second training stage based on self-supervised training on unlabeled real time-of-flight data. Multiple reflections of the illumination and the reflected light bouncing among objects and causing multi-path interference, MPI, in ToF acquisitions may be emulated more faithfully.

### TECHNICAL FIELD

The present disclosure generally pertains to an information processing device for a time-of-flight system, an information processing method for a time-of-flight system and a time-of-flight system.

### TECHNICAL BACKGROUND

Generally, the concept of a spatially varying bi-directional reflection distribution function, svBRDF, is known. The svBRDF of an object describes how light is reflected by each point on a surface of the object. For example, the svBRDF is used in an accurate simulation of light reflections in three-dimensional (3D) synthetic (computer-generated) scenes. Typically, it may be difficult, however, to measure this material property for each desired light spectrum for the object.

Recently, Boss et al., “Two-shot Spatially-varying BRDF and Shape Estimation”, in 2020 IEEE/CVF Conference on Computer Vision and Pattern Recognition (CVPR), Seattle, WA, USA, 2020 pp. 3981-3990, doi: 10.1109/CVPR42600.2020.00404, proposed to estimate the svBRDF in the visible light spectrum based on RGB (“red-green-blue”) camera recordings and a deep learning approach. In Boss et al., a scene geometry is inferred from the RGB camera recordings, which is basically required for the estimation of the svBRDF.

However, in some cases, the estimation of the scene geometry from RGB camera recordings of a single camera system may be difficult.

Although there exist techniques for estimating the svBRDF of an object, it is generally desirable to improve the existing techniques.

### SUMMARY

According to a first aspect the disclosure provides an information processing device for a time-of-flight system, comprising circuitry configured to:
obtain time-of-flight data of at least one time-of-flight measurement of light reflected from a scene that is illuminated with infrared light; and
input the time-of-flight data into a neural network, wherein the neural network is trained to estimate, for each pixel or a subset of pixels of the time-of-flight data, a spatially varying bi-directional reflection distribution function.

According to a second aspect the disclosure provides an information processing method for a time-of-flight system, the information processing method comprising:
obtaining time-of-flight data of at least one time-of-flight measurement of light reflected from a scene that is illuminated with infrared light; and
inputting the time-of-flight data into a neural network, wherein the neural network is trained to estimate, for each pixel or a subset of pixels of the time-of-flight data, a spatially varying bi-directional reflection distribution function.

According to a third aspect the disclosure provides a time-of-flight system, comprising:
an illumination device including a light source configured to illuminate a scene with infrared light for at least one time-of-flight measurement;
an imaging device, including an image sensor, configured to image light reflected from the scene on the image sensor and to generate time-of-flight data of the at least one time-of-flight measurement in accordance with the light imaged on the image sensor; and
an information processing device including circuitry configured to:
   obtain the time-of-flight data of the at least one time-of-flight measurement of the light reflected from the scene that is illuminated with infrared light; and
   input the time-of-flight data into a neural network, wherein the neural network is trained to estimate, for each pixel or a subset of pixels of the time-of-flight data, a spatially varying bi-directional reflection distribution function.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically illustrates parameters of a spatially varying bi-directional reflection distribution function;

FIG. 2 schematically illustrates in a block diagram an embodiment of a time-of-flight system;

FIG. 3 schematically illustrates an embodiment of a light modulation signal, a reflected illumination light signal and four demodulation signals;

FIG. 4 schematically illustrates in FIG. 4A in a block diagram a first training stage of a neural network for estimating a spatially varying bi-directional reflection distribution function, and in FIG. 4B in a block diagram a second training stage of the neural network for estimating a spatially varying bi-directional reflection distribution function;

FIG. 5 schematically illustrates in a block diagram an embodiment of a method for simulating time-of-flight data; and

FIG. 6 schematically illustrates in a flow diagram an embodiment of an information processing method.

### DETAILED DESCRIPTION OF EMBODIMENTS

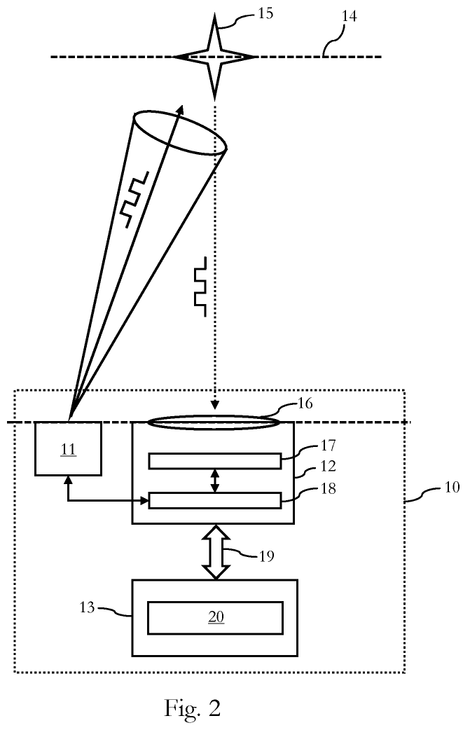

Before a detailed description of the embodiments under reference of FIG. 2 is given, general explanations are made.

As mentioned in the outset, generally, the concept of a spatially varying bi-directional reflection distribution function, svBRDF, is known. The svBRDF of an object describes how light is reflected by each point on a surface of the object. Typically, it may be difficult, however, to measure this material property for each desired light spectrum for the object.

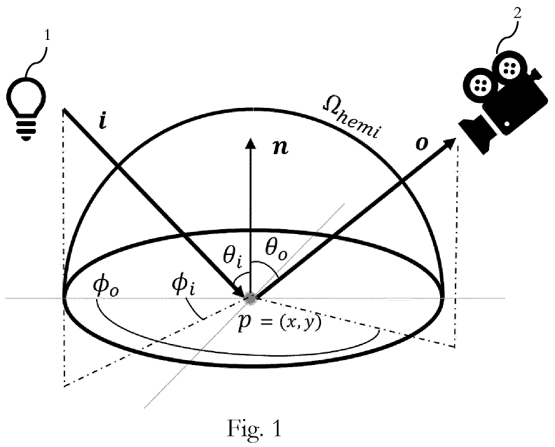

For enhancing the general understanding of the present disclosure, parameters of the svBRDF are discussed under reference of FIG. 1, which schematically illustrates the parameters.

A light source 1 illuminates a point p on a surface of an object (not shown) in a scene with light, wherein the illumination light reaches point p in an incoming direction i. The object reflects some of the incoming light in point p in an outgoing direction o.

A camera 2 acquires an image of the scene, wherein the outgoing light from point p on the surface of the object reaches the camera 2 in the outgoing direction o.

The incoming direction i is described by angles ϕᵢ, θᵢ which are given with respect to a coordinate system defined by a surface normal vector n of the surface of the object in point p, wherein θᵢ is the angle between the incoming direction i and the surface normal vector n.

The outgoing direction o is described by angles ϕₒ, θₒ which are given with respect to the coordinate system defined by the normal vector n of the surface of the object in point p, wherein θₒ is the angle between the outgoing direction o and the surface normal vector n.

The role of the svBRDF in the process of image formation can then be described by the rendering equation:

$${L}_{o} ( p , o ) = {L}_{e} ( p , o ) + {\int }_{{Ω}_{h e m i}} {f}_{r} ( p , i \to o ) \cdot {L}_{i} ( p , i ) \cdot cos ( {θ}_{i} ) d {Ω}_{i} ,$$

wherein Lₒ(p, o) is the outgoing radiance for the point p that is observed by the camera 2 (basically what a pixel of the camera 2 measures) for an outgoing direction o, Lₑ(p, o) is the radiance emitted by the point p on the surface of the object for an outgoing direction o independent of the incoming light (e.g., the object may be a light source itself), Lᵢ(p, i) is the incoming radiance for the point p for an incoming direction i, Ωₕₑₘᵢ is the set of all the directions in the sampled hemisphere, dΩᵢ is the infinitesimal solid angle sampled in Ωₕₑₘᵢ whose center is the incoming direction i, and ƒᵣ(p, i→o) is a scattering function that expresses for each point p how the incoming radiance in the incoming direction i is reflected for each outgoing direction o.

The scattering function ƒᵣ(p, i→0) is the spatially varying bi-directional reflection distribution function, svBRDF. Basically, the svBRDF describes how light is reflected by each point on a surface of the object and has an important role, e.g., for accurately simulating light reflections in three-dimensional (3D) synthetic (computer-generated) scenes.

From the rendering equation it is clear that the geometry of the scene has a key role in the image formation process, since both o and i are defined with respect to the surface normal of the object at the observed point.

It has thus been recognized that time-of-flight data obtained with a time-of-flight system may be used for estimating the svBRDF, since distance information to each point in the scene is already included in the time-of-flight data and, thus, the scene geometry is encoded in the time-of-flight data. Hence, additional processing procedures, as for RGB image-based svBRDF estimation, may not be required. As mentioned in the outset, in some cases, the estimation of the scene geometry from RGB camera recordings of a single camera system may be difficult.

Moreover, typically, time-of-flight systems operate in the infrared spectrum. Hence, it has been recognized that infrared light may be used for determining the svBRDF in the infrared spectrum such that more realistic time-of-flight system simulations may be achieved and difficulties in estimating the scene geometry from RGB camera recordings may be circumvented.

Hence, some embodiments pertain to an information processing device for a time-of-flight system, wherein the information processing device includes circuitry configured to:
obtain time-of-flight data of at least one time-of-flight measurement of light reflected from a scene that is illuminated with infrared light; and
input the time-of-flight data into a neural network, wherein the neural network is trained to estimate, for each pixel or a subset of pixels of the time-of-flight data, a spatially varying bi-directional reflection distribution function.

The circuitry may be based on or may include or may be implemented as integrated circuitry logic or may be implemented by a CPU (central processing unit), an application processor, a graphical processing unit (GPU), a microcontroller, an FPGA (field programmable gate array), an ASIC (application specific integrated circuit) or the like. The functionality may be implemented by software executed by a processor such as an application processor or the like. The circuitry may be based on or may include or may be implemented by typical electronic components configured to achieve the functionality as described herein. The circuitry may be based on or may include or may be implemented in parts by typical electronic components and integrated circuitry logic and in parts by software.

The circuitry may include a communication interface configured to communicate and exchange data with a computer or processor (e.g. an application processor or the like) over a network (e.g. the internet) via a wired or a wireless connection such as WiFi®, Bluetooth® or a mobile telecommunications system which may be based on UMTS, LTE or the like (and implements corresponding communication protocols). The circuitry may include a data bus (interface) (e.g. a Camera Serial Interface (CSI) in accordance with MIPI (Mobile Industry Processor Interface) specifications (e.g. MIPII CSI-2 or the like) or the like). The circuitry may include the data bus (interface) for transmitting (and receiving) data over the data bus.

The circuitry may include data storage capabilities to store data such as memory which may be based on semiconductor storage technology (e.g. RAM, EPROM, etc.) or magnetic storage technology (e.g. a hard disk drive) or the like.

Accordingly, the svBRDF is estimated in the infrared spectrum based on a deep learning method to generate it. Herein, the svBRDF is estimated starting from time-of-flight data captured by (indirect) time-of-flight systems. The infrared light may be near infrared light (e.g., wavelengths between about 780 nm and 3.0 μm (“micrometer”)), middle infrared light (e.g., wavelengths between 3.0 and 50.0 μm) or far infrared light, a combination of them (partially or fully), or the like.

Generally, the estimated svBRDF may be used for different applications, for example, material property analysis, automatic creation of 3D synthetic scene models and scene rendering in the infrared spectrum. In particular, the latter may be used as input of simulators for ToF systems.

Some embodiments pertain to a time-of-flight system, wherein the time-of-flight system includes:
an illumination device including a light source configured to illuminate a scene with infrared light for at least one time-of-flight measurement;
an imaging device, including an image sensor, configured to image light reflected from the scene on the image sensor and to generate time-of-flight data of the at least one time-of-flight measurement in accordance with the light imaged on the image sensor; and
an information processing device including circuitry configured to:
   obtain the time-of-flight data of the at least one time-of-flight measurement of the light reflected from the scene that is illuminated with infrared light; and
   input the time-of-flight data into a neural network, wherein the neural network is trained to estimate, for each pixel or a subset of pixels of the time-of-flight data, a spatially varying bi-directional reflection distribution function.

The time-of-flight (hereinafter: ToF) system may be an indirect ToF system.

Typically, in some embodiments, an indirect ToF system obtains depth data from correlation data, wherein the indirect ToF system obtains the correlation data in a plurality of correlation measurements. In such embodiments, in a correlation measurement, a light source illuminates a scene with modulated light (at least modulated in time) and an image sensor acquires the modulated light reflected from the scene, wherein a light modulation signal applied to the light source and a demodulation signal applied to the image sensor are phase-shifted with respect to each other. For example, the plurality of correlation measurements may be four correlation measurements with phase shifts of 0°, 90°, 180° and 270°. In such embodiments, the ToF obtains a phase shift between the emitted light and the reflected light, which is indicative for a distance to objects in the scene, based on the correlation data.

Generally, a ToF system which generates such correlation data is a ToF system in accordance with the present disclosure in some embodiments. A time-of-flight measurement may include the plurality of correlation measurements.

The illumination device may include optical elements such as lenses, mirrors, optical filter (e.g., optical bandpass filter, polarization filter, etc.), diffractive optical elements, etc.

The light source may be or include a laser (e.g. a laser diode) or a plurality of lasers (e.g. a plurality of laser diodes arranged in rows and columns), a light emitting diode (LED) or a plurality of LEDs (e.g. a plurality of LEDs arranged in rows and columns), or the like.

The light source is configured to emit infrared light. The light source has a spectral emission profile with a center wavelength in the infrared spectrum. The infrared light may be near infrared light such that the light source is configured to emit light with a spectral emission profile with a center wavelength, for example, between 780 nm and 3.0 μm (“micrometer”)). The infrared light may be middle infrared light such that the light source is configured to emit light with a spectral emission profile with a center wavelength, for example, between 3.0 and 50.0 μm. In some embodiments, the whole infrared spectrum is covered or only a part of it.

The light source is configured to modulate an intensity of the emitted light/illumination light (in time) according to a light modulation signal applied to the light source, for example, a sinusoidal light modulation signal with a predetermined frequency, a rectangular modulation signal with a predetermined frequency (e.g. the emitted light is turned on for a first predetermined time period, then turned off for a second predetermined time period and so) or the like, as generally known.

In some embodiments, the light source is configured to illuminate the scene with flooded (e.g. continuous) light, with spotted light, light pulses or a combination thereof.

The imaging device may include optical elements such as lenses, mirrors, optical filter (e.g., optical bandpass filter, polarization filter, etc.), diffractive optical elements, etc.

The imaging device may include a control for controlling the overall operation of the ToF system. The control may further be configured to generate amplitude data, intensity data and depth data based on obtained correlation data.

The image sensor may include a pixel circuitry (e.g., driving units, signal processing, analog-to-digital conversion etc.) having a plurality of pixels (arranged according to a predetermined pattern, e.g., in rows and columns in the image sensor) generating an electric signal in accordance with an amount of light incident on each of the plurality of pixels and in accordance with a demodulation signal applied to the respective pixel which modulates, for example, a gain of the plurality of pixels. The demodulation signal corresponds to the light modulation signal applied to the light source. The demodulation signal for the image sensor may be phase-shifted with respect to the light modulation signal for the light source.

The plurality of pixels may be current assisted photonic demodulator (CAPD) pixels, photodiode pixels or active pixels based on, for example, CMOS (complementary metal oxide semiconductor) technology etc., wherein, for example, a gain of the plurality of pixels is modulated based on the demodulation signal. The plurality of pixels may be single-tap, two-tap, four-tap, etc. current assisted photonic demodulator (CAPD) pixels.

The circuitry of the information processing device obtains time-of-flight data of at least one time-of-flight measurement of light reflected from a scene that is illuminated with infrared light.

In some embodiments, the time-of-flight data include correlation data.

As mentioned above, the correlation data are generated in a plurality of correlation measurements by the image sensor. The correlation data include pixel values of the plurality of pixels obtained for different demodulation signals with respect to a phase-shift between the demodulation signals and the light modulation signal (e.g., phase-shifted with 0°, 90°, 180° and) 270°.

In some embodiments, the time-of-flight data include amplitude data. In some embodiments, the circuitry of the information processing device is configured to generate the amplitude data based on the correlation data.

In some embodiments, the amplitude data are generated based on the correlation data.

In some embodiments, the amplitude data include or is representative of an in-phase component value (typically denoted with “I”, as generally known) and a quadrature component value (typically denoted with “Q”, as generally known) for each of the plurality of pixels or for each pixel of a subset of the plurality of pixels or a subset (or two or more subsets) of the plurality of pixels (e.g., a pixel block (or two or more pixel blocks) for accumulating two or more adjacent pixels).

In some embodiments, the amplitude data are related to the sum of the square of the in-phase component value and the square of the quadrature component value.

In some embodiments, the amplitude data—are related to a signal strength of the received modulated light. In some embodiments, the amplitude values are independent from the ambient light.

In some embodiments, the time-of-flight data include intensity data. In some embodiments, the circuitry of the information processing device is configured to generate the intensity data based on the correlation data (based on the plurality of correlation measurements).

In some embodiments, the intensity data are generated based on the correlation data (based on the plurality of correlation measurements).

In some embodiments, the intensity data include or is representative of an intensity value for each of the plurality of pixels or each pixel of a subset of the plurality of pixels or a subset (or two or more subsets) of the plurality of pixels (e.g., a pixel block (or two or more pixel blocks) for accumulating two or more adjacent pixels.

In some embodiments, the intensity value is proportional to the sum of the pixel values of the correlation data for the different phase shifts.

In some embodiments, the intensity data are proportional to the amount of light incident on the respective pixel. In some embodiments, the intensity values-represented by the intensity data—are proportional to the ambient light. In some embodiments, the intensity values are related to the ambient light and the signal strength of the received modulated light.

Boss et al. (see technical background in the outset) proposed to use two RGB images of a scene as input for a neural network, one under ambient illumination and the second with a camera flash on.

It has been recognized that with a ToF system the amplitude data and the intensity data of a single time-of-flight measurement may be used with the same role, since the amplitude data depend on the received modulated light, which thus represent a flash-on image, and the intensity data depend on the ambient light and the received modulated light, which thus represents an image under ambient illumination. Hence, in some embodiments, the time-of-flight data can be used to separate ambient light and active light (received modulated light) and, thus, are similar in some embodiments to RGB images with and without flash.

Hence, in some embodiments, the time-of-flight data include the amplitude data and the intensity data.

In some embodiments, the time-of-flight data include depth data. In some embodiments, the circuitry of the information processing device is configured to generate the depth data based on the correlation data (based on the plurality of correlation measurements).

In some embodiments, the depth data are generated based on the correlation data (based on the plurality of correlation measurements).

In some embodiments, the at least one time-of-flight measurement is a single time-of-flight measurement.

It has been recognized that the svBRDF may be estimated more accurately in some cases when the scene is observed from more than a single viewpoint (more than one outgoing direction o).

Hence, in some embodiments, the at least one time-of-flight measurement includes a first time-of-flight measurement at a first viewpoint and a second time-of-flight measurement at a second viewpoint being different than the first viewpoint.

In such embodiments, the time-of-flight data include first time-of-flight data of the first time-of-flight measurement and second time-of-flight data of the second time-of-flight measurement.

The first and the second viewpoint may be predetermined such that an association of the first time-of-flight data and the second time-of-flight data is predetermined such that identical parts of the scene (identical points in the scene) can be merged for estimating the svBRDF for identical points in the scene based on two time-of-flight measurements, whereby more than one outgoing direction o is sampled.

The association of the first time-of-flight data and the second time-of-flight data may be based on scene analysis in which the depth data is used for generating a scene geometry model at each viewpoint such that identical parts (identical points in the scene) can be merged for estimating the svBRDF for identical points in the scene based on two time-of-flight measurements, whereby more than one outgoing direction o is sampled.

The present disclosure is not limited to two time-of-flight measurements at two different viewpoints. The at least one time-of-flight measurement may include a plurality of time-of-flight measurements at a plurality of different viewpoints. For example, the ToF system may be moved around a target object while performing a plurality of time-of-flight measurements.

The circuitry of the information processing device inputs the time-of-flight data into a neural network, wherein the neural network is trained to estimate, for each pixel or a subset of pixels of the time-of-flight data, a spatially varying bi-directional reflection distribution function.

Hence, in some embodiments, the svBRDF is estimated for each pixel of the plurality of pixels.

Thus, in some embodiments, the svBRDF is estimated for each pixel of a subset of the plurality of pixels. For example, only for pixels which correspond to a part of the scene in which an object is detected.

Hence, in some embodiments, the svBRDF is estimated for each pixel block of a plurality of pixel blocks. For example, the plurality of pixels may be divided in pixel blocks, wherein each pixel block corresponds to two or more adjacent pixels.

The neural network may include one or more fully connected layers, one or more convolutional layers, one or more activation layers, or the like.

The output of the neural network is the svBRDF for each pixel of the obtained time-of-flight data.

The svBRDF may be represented by parameters of an analytical model, e.g., the parameters of a Cook-Torrance material model (Cook et al., “A Reflectance Model for Computer Graphics”, ACM Transactions on Graphics, Volume 1, Issue 1, January 1982, pp 7-24, https://doi.org/10.1145/357290.357293) or of a Disney material model (B. Burley, “Physically-Based Shading at Disney”, SIGGRAPH 2012), or as a set of sampling points for some viewpoints and incident light directions.

The svBRDF may be represented as a decomposition of parameters of a material as diffuse color, local normals, metalness and roughness (see, e.g., https://cc0textures.com). These parameters may be fed into a material model to specify point by point what is the svBRDF characteristic.

Hence, in some embodiments, the spatially varying bi-directional reflection distribution function is represented by parameters of a material model.

In some embodiments, the spatially varying bi-directional reflection distribution function is represented by a set of sampling points.

Basically, to train the neural network in a supervised way on real data, it would be required to collect couples of time-of-flight data and the related svBRDF (parameters) per pixel, however, this may not be feasible in some instances for real time-of-flight measurements.

Hence, in some embodiments, the neural network is trained based on synthetic data.

In such embodiments, three-dimensional (3D) synthetic (computer-generated) scenes are used in which the related svBRDF is applied to each object to render the synthetic scenes. In such embodiments, the rendered synthetic scenes are used for generating synthetic time-of-flight data by simulating time-of-flight measurements of the rendered synthetic scenes. In such embodiments, the synthetic time-of-flight data are input to the neural network during training which estimates the svBRDF per pixel. In such embodiments, a loss function generates weight updates for the neural network based on a difference between the estimated svBRDF and the known svBRDF applied to the objects in the synthetic scenes.

However, it has been recognized that a training based on synthetic scenes may be improved for the application to real time-of-flight data by a second training stage based on self-supervised training on unlabeled real time-of-flight data.

In some embodiments, this is implemented by using a loss function for minimizing the difference between the input real time-of-flight data and its re-rendered version generated from a scene geometry model and the svBRDF estimated with the neural network from the input real time-of-flight data.

As described herein, a task is to estimate the svBRDF of objects in a scene, starting from a single or multiple time-of-flight measurements. The estimation can be based on a deep learning technique that takes the time-of-flight data as input and outputs the estimated svBRDF related to the material properties of the target material at the working spectrum of the ToF system.

Generally, as mentioned above, the estimated svBRDF may be used for different applications, for example, material property analysis, automatic creation of 3D synthetic scene models and scene rendering in the infrared spectrum. In particular, the latter may be used as input of simulators for ToF systems.

For example, the svBRDF of real objects can be estimated at the specific light spectrum used by the ToF systems, e.g., 940 nm (center wavelength) (without limiting the present disclosure to this specific wavelength). These light spectral bands usually belong to the near infrared spectrum and they are typically not covered by standard RGB cameras. The measured svBRDFs may be used to apply realistic material properties to 3D synthetic scenes. These realistic 3D synthetic scene models may be used in the context of ToF system simulation in order to emulate properly material reflection properties of real objects.

Thus, it may be possible to emulate more faithfully multiple reflections of the illumination and the reflected light bouncing among objects and causing multi-path interference (MPI) in ToF acquisitions. The MPI is typically one of the most critical error sources in ToF system depth recordings and for this reason it may be critical to have realistic material properties in ToF simulations. The generated simulated time-of-flight data, for which all the characteristics of the synthetic scene model are known, e.g., depth, scene normal, ToF system viewpoint, material properties, can be used for training machine learning systems in supervised, self-supervised or weakly supervised manners.

Hence, some embodiments pertain to a method for simulating time-of-flight data, wherein the method includes:
obtaining time-of-flight data of at least one real time-of-flight measurement of light reflected from a real object in a real scene that is illuminated with infrared light;
inputting the time-of-flight data into a neural network, wherein the neural network is trained to estimate, for each pixel or a subset of pixels of the time-of-flight data, a spatially varying bi-directional reflection distribution function of the real object;
generating a synthetic scene which includes a synthetic object corresponding to the real object in the real scene;
applying the estimated spatially varying bi-directional reflection distribution function on the synthetic object; and
simulating at least one time-of-flight measurement of the synthetic scene for generating simulated time-of-flight data of the at least one time-of-flight measurement of the synthetic scene.

Another use case involves the employment of the estimated svBRDF, by processing time-of-flight data, as input of processing pipelines for the depth refinement of time-of-flight data. Since the svBRDF provides information on how the light is reflected in the scene, this information can be used by machine learning or analytical methods for estimating how the ToF modulated light interferes due to multiple reflections among the scene objects. By consequence, the svBRDF information can be used by methods for correcting MPI distortion in time-of-flight data such as depth data representing a depth map of the scene.

A further use case may be, e.g., in mobile devices to improve the quality of the acquired time-of-flight data, to classify the materials in the surrounding and improve the quality of augmented reality. The ToF system typically works at an invisible wavelength such as infrared. However, reflectance properties of most materials have a smooth behavior such that wavelengths in the same order of magnitude show similar interaction, especially for specular reflections. These specular reflections are extremely important in creating immersive augmented reality because augmented content has to be reflected properly on glossy surfaces.

Some embodiments pertain to an information processing method for a time-of-flight system, wherein the information processing method includes:
obtaining time-of-flight data of at least one time-of-flight measurement of light reflected from a scene that is illuminated with infrared light; and
inputting the time-of-flight data into a neural network, wherein the neural network is trained to estimate, for each pixel or a subset of pixels of the time-of-flight data, a spatially varying bi-directional reflection distribution function.

The information processing method may be performed by the information processing device as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

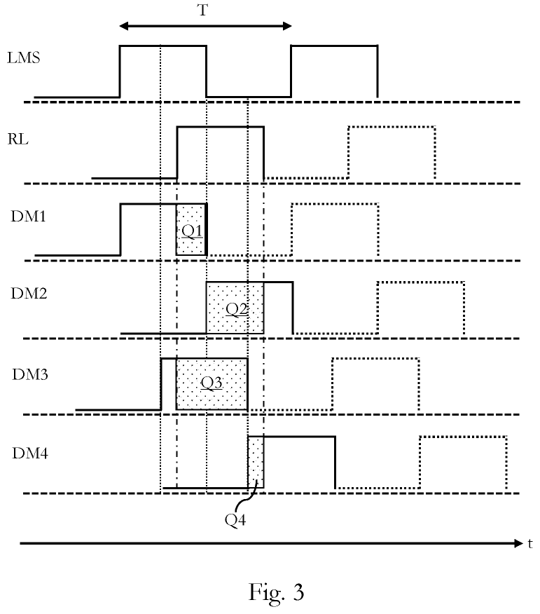

Returning to FIG. 2, there is illustrated an embodiment of a time-of-flight system 10, hereinafter ToF system 10, which is discussed in the following under reference of FIG. 2. The ToF system 10 is further discussed under reference of FIG. 3 in which an embodiment of a light modulation signal of a light source, a reflected light signal and four demodulation signals is schematically illustrated.

The ToF system 10 includes an illumination device 11, an imaging device 12 and an information processing device 13.

The illumination device includes a light source (not shown) that illuminates a scene 14 with infrared light. The scene 14 includes an object 15 which reflects at least partially the infrared illumination light from the light source.

The imaging device 12 includes an optical lens portion 16, an image sensor 17 and a control 18.

At least a part of the reflected illumination light from the object 15 is imaged by the optical lens portion 16 on the image sensor 17.

The control 18 basically controls the overall operation of the ToF system 10 and applies a light modulation signal to the illumination device 11 such that the light source illuminates the scene with intensity-modulated (in time) infrared light.

The control 18 further applies a demodulation signal to the image sensor 17, wherein the demodulation signal has a predetermined phase shift with respect to the light modulation signal for generating correlation data.

Here, the control 18 controls the ToF system 10 such that a time-of-flight measurement includes four correlation measurements for generating the correlation data, wherein the four correlation measurements have phase shifts of 0°, 90°, 180° and 270° between the light modulation signal applied to the illumination device 11 and the demodulation signal applied to the image sensor 17.

The light modulation signal, a reflected illumination light signal and the four demodulation signals are discussed under reference of FIG. 3 in the following.

The light modulation signal LMS applied to the illumination device 11 of FIG. 2 is a rectangular modulation signal with a modulation period T. An intensity of emitted infrared light of the light source is then modulated in time according to the light modulation signal LMS. The emitted infrared light is at least partially reflected at the object 15 in the scene 14.

The reflected illumination light signal RL is basically an intensity of the reflected illumination light at the image sensor 17 of FIG. 2, which is phase-shifted with respect to the light modulation signal LMS and varies according to the intensity-modulation of the emitted infrared light. The phase is proportional to a distance to the object 15 in the scene 14.

The image sensor 17 captures four frames corresponding to the demodulation signals DM1, DM2, DM3 and DM4.

The demodulation signal DM1 is phase-shifted by 0° with respect to the light modulation signal LMS. When the demodulation signal DM1 is high, the image sensor 17 (each of the plurality of pixels) accumulates an electrical charge Q1 in accordance with an amount of light incident on the respective pixel and an overlap of the reflected illumination light signal RL and the demodulation signal DM1.

The demodulation signal DM2 is phase-shifted by 90° with respect to the light modulation signal LMS. When the demodulation signal DM2 is high, the image sensor 17 (each of the plurality of pixels) accumulates an electrical charge Q2 in accordance with an amount of light incident on the respective pixel and an overlap of the reflected illumination light signal RL and the demodulation signal DM2.

The demodulation signal DM3 is phase-shifted by 180° with respect to the light modulation signal LMS. When the demodulation signal DM3 is high, the image sensor 17 (each of the plurality of pixels) accumulates an electrical charge Q3 in accordance with an amount of light incident on the respective pixel and an overlap of the reflected illumination light signal RL and the demodulation signal DM3.

The demodulation signal DM4 is phase-shifted by 270° with respect to the light modulation signal LMS. When the demodulation signal DM4 is high, the image sensor 17 (each of the plurality of pixels) accumulates an electrical charge Q4 in accordance with an amount of light incident on the respective pixel and an overlap of the reflected illumination light signal RL and the demodulation signal DM4.

The electrical charges Q1, Q2, Q3 and Q4, as generally known, are proportional to, e.g., a voltage signal (electric signal) of the respective pixel from which the pixel values are obtained and output by the image sensor 17 and, thus, the electrical charges Q1, Q2, Q3 and Q4 are representative for the pixel values and represent the correlation data.

Then, the phase between the light modulation signal LMS and the reflected illumination light signal RL is given by:

$$phase = arctan ( \frac{Q 4 - Q 2}{Q 1 - Q 3} ) = arctan ( \frac{Q}{l} ) ,$$

$$Q = Q 4 - Q 2 ,$$

$$I = Q 1 - Q 3.$$

Here, Q is the quadrature component and I is the in-phase component, which are together the amplitude data of a pixel (also known as IQ value).

The intensity of the reflected illumination light signal RL is proportional to the intensity value.

The intensity data include for each pixel an intensity value.

In some embodiments, the amplitude data are given by:

$$amplitude = \frac{\sqrt{{Q}^{2} + {I}^{2}}}{2} .$$

Then, the intensity data are given by:

$$intensity = \frac{Q 1 + Q 2 + Q 3 + Q 4}{4} .$$

Returning to FIG. 2, the control 18 transmits the correlation data via a data bus 19 to the information processing device 13, which obtains the correlation data as time-of-flight data.

The information processing device 13 includes circuitry (not shown), such as an application processor, on which a neural network 20 is implemented by software.

The circuitry of the information processing device 13 inputs the time-of-flight data into the neural network 20, wherein the neural network 20 is trained to estimate, for each pixel of the time-of-flight data, a spatially varying bi-directional reflection distribution function, svBRDF (in particular of the object 15).

In other embodiments, the circuitry of the information processing device 13 generates at least one of amplitude data, intensity data and depth data and inputs any combination of the correlation data, the amplitude data, the intensity data and the depth data into the neural network 20 for the estimation of the svBRDF (the neural network 20 is then adapted to such input data).

In other embodiments, the control 18 generates at least one of amplitude data, intensity data and depth data and transmits any combination of the correlation data, the amplitude data, the intensity data and the depth data via the data bus 18 to the information processing device 13 for the estimation of the svBRDF (the neural network 20 is then adapted to such input data).

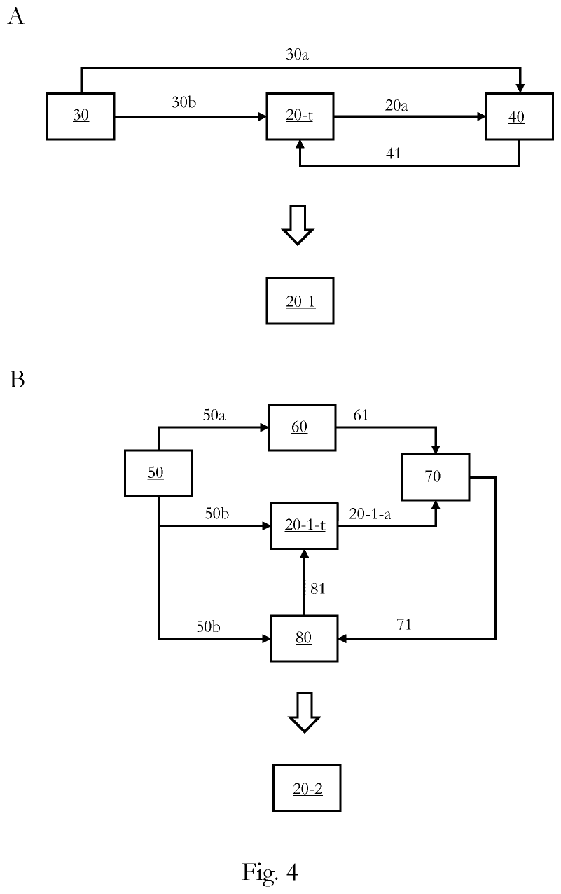

FIG. 4A of FIG. 4 schematically illustrates in a block diagram a first training stage of a neural network for estimating a spatially varying bi-directional reflection distribution function, and FIG. 4B schematically illustrates in a block diagram a second training stage of the neural network for estimating a spatially varying bi-directional reflection distribution function, which will be discussed in the following.

Referring to FIG. 4A, as mentioned above, to train the neural network 20 of FIG. 2 in a supervised way on real time-of-flight data, it would be required to collect couples of time-of-flight data and the related svBRDF (parameters) per pixel. However, this may not be feasible in some instances for real time-of-flight recordings.

Hence, in this embodiment, a first training stage is based on synthetic data 30.

The synthetic data 30 include svBRDF data 30a for each pixel of synthetic time-of-flight data 30b of a plurality of simulated time-of-flight measurements of synthetic scenes on which the corresponding svBRDFs (depending on the objects in the scene) are applied.

The synthetic time-of-flight data 30b is input to a neural network in a first training stage 20-t, wherein the neural network in the first training stage 20-t is configured to estimate, for each pixel of the synthetic time-of-flight data 30b, a svBRDF 20a.

A loss function 40 obtains the estimated svBRDF 20a and the svBRDF data 30a.

Based on a difference between them, the loss function 40 generates weight updates 41 (e.g., via backpropagation) for the neural network in the first training stage 20-t for improving the estimation of the svBRDF.

Once the first training stage is completed, a first stage neural network 20-1 is obtained.

Referring to FIG. 4B, as mentioned above, however, it has been recognized that a training based on synthetic scenes may be improved for the application to real time-of-flight data by a second training stage based on self-supervised training on unlabeled real time-of-flight data.

Hence, in this embodiment, a second training stage of the first stage neural network 20-1 is performed based on unlabeled real time-of-flight data 50.

The unlabeled real time-of-flight data 50 include depth data 50a and correlation data 50b as time-of-flight data (in other embodiments any combination of correlation data, amplitude data, intensity data and depth data may be used instead of the correlation data as time-of-flight data) of a plurality of real scenes.

The depth data 50a is input to a scene geometry generator 60 that is configured to generate a three-dimensional model 61 of the respective scene based on the depth data 50a.

The correlation data 50b is input to the first stage neural network in a second training stage 20-1-t.

The first stage neural network in the second training stage 20-1-t estimates, for each pixel of the correlation data 50b, a svBRDF 20-1-a.

The three-dimensional model 61 of the respective scene and the svBRDF 20-1-a is input to a time-of-flight simulator 70.

The time-of-flight simulator 70 is configured to generate a re-rendered scene by applying the svBRDF 20-1-a on the three-dimensional model 61.

The time-of-flight simulator 70 is further configured to simulate a time-of-flight measurement of the re-rendered scene to generate simulated correlation data 71.

A loss function 80 obtains the correlation data 50b and the simulated correlation data 71.

Based on a difference between them, the loss function 80 generates weight updates 81 (e.g., via backpropagation) for first stage neural network in a second training stage 20-1-t for improving the estimation of the svBRDF.

Once the second training stage is completed, the neural network 20 of FIG. 2 is obtained.

FIG. 5 schematically illustrates in a block diagram an embodiment of a method for simulating time-of-flight data, which is discussed in the following.

As mentioned above, for example, the svBRDF of real objects can be estimated at the specific light spectrum used by the ToF systems, e.g., 940 nm (center wavelength). These light spectral bands usually belong to the near infrared spectrum and they are typically not covered by standard RGB cameras. The measured svBRDFs may be used to apply realistic material properties to 3D synthetic scenes. These realistic 3D synthetic scenes may be used in the context of ToF system simulation in order to properly emulate material reflection properties of real objects.

This use case, namely a method for simulating time-of-flight data, is illustrated in FIG. 5 and will be discussed in the following under reference of FIG. 5.

The ToF system 10 of FIG. 2 performs a real time-of-flight measurement of a real scene which includes a real object and generates time-of-flight data 90 of the real time-of-flight measurement.

The information processing device 13 (not shown) of FIG. 2 obtains the time-of-flight data 90 and inputs the time-of-flight data 90 into the neural network 20 of FIG. 2.

The neural network 20 estimates, for each pixel of the time-of-flight data 90, a spatially varying bi-directional reflection distribution function of the real object.

A synthetic scene is generated which includes a synthetic object corresponding to the real object in the real scene, wherein the estimated spatially varying bi-directional reflection distribution function is applied on the synthetic object.

For example, if the real object is an object of a wooden material, then the synthetic object is also an object of a wooden material. The real object and the synthetic object may have the same form.

The synthetic scene is input to the time-of-flight simulator 70 of FIG. 4 which simulates a time-of-flight measurement of the synthetic scene for generating simulated time-of-flight data 96 of the at least one time-of-flight measurement of the synthetic scene.

A synthetic dataset 95 is obtained which includes the simulated time-of-flight data 96 and ground truth data 97 which include, for example, depth data of the synthetic scene, scene normal, ToF system viewpoint, material properties (e.g., surface roughness), etc.

The synthetic dataset 95 may be used for training machine learning systems in supervised, self-supervised or weakly supervised manners.

Moreover, it may be possible to emulate more faithfully multiple reflections of the illumination and the reflected light bouncing among objects and causing multi-path interference (MPI) in ToF acquisitions. The MPI is typically one of the most critic error sources in ToF system depth recordings and for this reason it may be critical to have realistic material properties in ToF simulations.

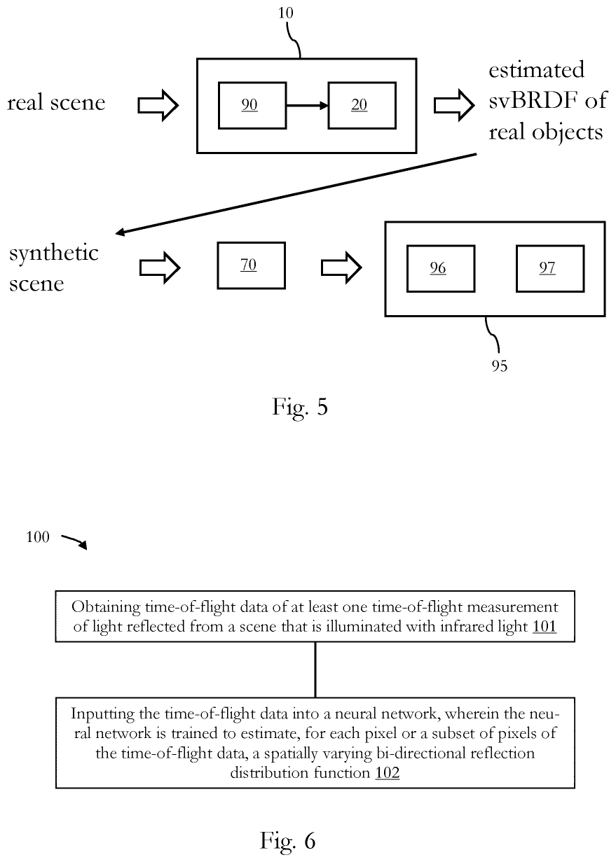

FIG. 6 schematically illustrates in a flow diagram an embodiment of an information processing method 100, which is discussed in the following.

The information processing method may be performed by the information processing device as described herein.

At 101, time-of-flight data is obtained of at least one time-of-flight measurement of light reflected from a scene that is illuminated with infrared light, as discussed herein.

At 102, the time-of-flight data is input into a neural network, wherein the neural network is trained to estimate, for each pixel of the time-of-flight data, a spatially varying bi-directional reflection distribution function, as discussed herein.

It should be recognized that the embodiments describe methods with an exemplary ordering of method steps. The specific ordering of method steps is however given for illustrative purposes only and should not be construed as binding.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) An information processing device for a time-of-flight system, including circuitry configured to:
   obtain time-of-flight data of at least one time-of-flight measurement of light reflected from a scene that is illuminated with infrared light; and
   input the time-of-flight data into a neural network, wherein the neural network is trained to estimate, for each pixel or a subset of pixels of the time-of-flight data, a spatially varying bi-directional reflection distribution function.
(2) The information processing device of (1), wherein the time-of-flight data include correlation data.
(3) The information processing device of (1) or (2), wherein the time-of-flight data include amplitude data.
(4) The information processing device of anyone of (1) to (3), wherein the time-of-flight data include intensity data.
(5) The information processing device of anyone of (1) to (4), wherein the time-of-flight data include depth data.
(6) The information processing device of anyone of (1) to (5), wherein the at least one time-of-flight measurement is a single time-of-flight measurement.
(7) The information processing device of anyone of (1) to (5), wherein the at least one time-of-flight measurement includes a first time-of-flight measurement at a first viewpoint and a second time-of-flight measurement at a second viewpoint being different than the first viewpoint.
(8) The information processing device of anyone of (1) to (7), wherein the spatially varying bi-directional reflection distribution function is represented by parameters of a material model.
(9) The information processing device of anyone of (1) to (7), wherein the spatially varying bi-directional reflection distribution function is represented by a set of sampling points.
(10) An information processing method for a time-of-flight system, the information processing method including:
   obtaining time-of-flight data of at least one time-of-flight measurement of light reflected from a scene that is illuminated with infrared light; and
   inputting the time-of-flight data into a neural network, wherein the neural network is trained to estimate, for each pixel or a subset of pixels of the time-of-flight data, a spatially varying bi-directional reflection distribution function.
(11) The information processing method of (10), wherein the time-of-flight data include correlation data.
(12) The information processing method of (10) or (11), wherein the time-of-flight data include amplitude data.
(13) The information processing method of anyone of (10) to (12), wherein the time-of-flight data include intensity data.
(14) The information processing method of anyone of (10) to (13), wherein the time-of-flight data include depth data.
(15) The information processing method of anyone of (10) to (14), wherein the at least one time-of-flight measurement is a single time-of-flight measurement.
(16) The information processing method of anyone of (10) to (14), wherein the at least one time-of-flight measurement includes a first time-of-flight measurement at a first viewpoint and a second time-of-flight measurement at a second viewpoint being different than the first viewpoint.
(17) The information processing method of anyone of (10) to (16), wherein the spatially varying bi-directional reflection distribution function is represented by parameters of a material model.
(18) The information processing method of anyone of (10) to (16), wherein the spatially varying bi-directional reflection distribution function is represented by a set of sampling points.
(19) A time-of-flight system, including:
   an illumination device including a light source configured to illuminate a scene with infrared light for at least one time-of-flight measurement;
   an imaging device, including an image sensor, configured to image light reflected from the scene on the image sensor and to generate time-of-flight data of the at least one time-of-flight measurement in accordance with the light imaged on the image sensor; and
   an information processing device including circuitry configured to:
      obtain the time-of-flight data of the at least one time-of-flight measurement of the light reflected from the scene that is illuminated with infrared light; and
      input the time-of-flight data into a neural network, wherein the neural network is trained to estimate, for each pixel or a subset of pixels of the time-of-flight data, a spatially varying bi-directional reflection distribution function.
(20) The time-of-flight system of (19), wherein the light source is configured to illuminate the scene with flooded light or with spotted light.
(21) A computer program comprising program code causing a computer to perform the method according to anyone of (10) to (18), when being carried out on a computer.
(22) A non-transitory computer-readable recording medium that stores therein a computer program product, which, when executed by a processor, causes the method according to anyone of (10) to (18) to be performed.
(23) A method for simulating time-of-flight data, the method comprising:
   obtaining time-of-flight data of at least one real time-of-flight measurement of light reflected from a real object in a real scene that is illuminated with infrared light;
   inputting the time-of-flight data into a neural network, wherein the neural network is trained to estimate, for each pixel or a subset of pixels of the time-of-flight data, a spatially varying bi-directional reflection distribution function of the real object;
   generating a synthetic scene which includes a synthetic object corresponding to the real object in the real scene;
   applying the estimated spatially varying bi-directional reflection distribution function on the synthetic object; and
   simulating at least one time-of-flight measurement of the synthetic scene for generating simulated time-of-flight data of the at least one time-of-flight measurement of the synthetic scene.
(24) A computer program comprising program code causing a computer to perform the method according to (23), when being carried out on a computer.
(25) A non-transitory computer-readable recording medium that stores therein a computer program product, which, when executed by a processor, causes the method according to (23) to be performed.

1. An information processing device for a time-of-flight system, comprising circuitry configured to:
obtain time-of-flight data of at least one time-of-flight measurement of light reflected from a scene that is illuminated with infrared light; and
input the time-of-flight data into a neural network, wherein the neural network is trained to estimate, for each pixel or a subset of pixels of the time-of-flight data, a spatially varying bi-directional reflection distribution function.

2. The information processing device according to claim 1, wherein the time-of-flight data include correlation data.

3. The information processing device according to claim 1, wherein the time-of-flight data include amplitude data.

4. The information processing device according to claim 1, wherein the time-of-flight data include intensity data.

5. The information processing device according to claim 1, wherein the time-of-flight data include depth data.

6. The information processing device according to claim 1, wherein the at least one time-of-flight measurement is a single time-of-flight measurement.

7. The information processing device according to claim 1, wherein the at least one time-of-flight measurement includes a first time-of-flight measurement at a first viewpoint and a second time-of-flight measurement at a second viewpoint being different than the first viewpoint.

8. The information processing device according to claim 1, wherein the spatially varying bi-directional reflection distribution function is represented by parameters of a material model.

9. The information processing device according to claim 1, wherein the spatially varying bi-directional reflection distribution function is represented by a set of sampling points.

10. An information processing method for a time-of-flight system, the information processing method comprising:
obtaining time-of-flight data of at least one time-of-flight measurement of light reflected from a scene that is illuminated with infrared light; and
inputting the time-of-flight data into a neural network, wherein the neural network is trained to estimate, for each pixel or a subset of pixels of the time-of-flight data, a spatially varying bi-directional reflection distribution function.

11. The information processing method according to claim 10, wherein the time-of-flight data include correlation data.

12. The information processing method according to claim 10, wherein the time-of-flight data include amplitude data.

13. The information processing method according to claim 10, wherein the time-of-flight data include intensity data.

14. The information processing method according to claim 10, wherein the time-of-flight data include depth data.

15. The information processing method according to claim 10, wherein the at least one time-of-flight measurement is a single time-of-flight measurement.

16. The information processing method according to claim 10, wherein the at least one time-of-flight measurement includes a first time-of-flight measurement at a first viewpoint and a second time-of-flight measurement at a second viewpoint being different than the first viewpoint.

17. The information processing method according to claim 10, wherein the spatially varying bi-directional reflection distribution function is represented by parameters of a material model.

18. The information processing method according to claim 1, wherein the spatially varying bi-directional reflection distribution function is represented by a set of sampling points.

19. A time-of-flight system, comprising:
an illumination device including a light source configured to illuminate a scene with infrared light for at least one time-of-flight measurement;
an imaging device, including an image sensor, configured to image light reflected from the scene on the image sensor and to generate time-of-flight data of the at least one time-of-flight measurement in accordance with the light imaged on the image sensor; and
an information processing device including circuitry configured to:
obtain the time-of-flight data of the at least one time-of-flight measurement of the light reflected from the scene that is illuminated with infrared light; and
input the time-of-flight data into a neural network, wherein the neural network is trained to estimate, for each pixel or a subset of pixels of the time-of-flight data, a spatially varying bi-directional reflection distribution function.

20. The time-of-flight system according to claim 19, wherein the light source is configured to illuminate the scene with flooded light or with spotted light.
